(19) United States
(12) Patent Application Publication
(10) Pub. No.: US 2002/0135793 A1
(43) Pub. Date: Sep. 26, 2002

(54) Apparatus and method for a programmable detack charging system

(76) Inventors: George R. Walgrove III, Rochester, NY (US); Timothy W. Reynolds, Rochester, NY (US)

Correspondence Address: BRINKS HOFER GILSON & LIONE, P.O. BOX 10395, CHICAGO, IL, 60610, US

(21) Appl. No.: 10/054,436

(22) Filed: Jan. 18, 2002

Related U.S. Application Data
(60) Provisional application No. 60/262,953, filed on Jan. 19, 2001.

(51) Int. Cl. B41F 1/00; G06F 15/00

(52) U.S. Cl. 358/1.14

(57) ABSTRACT

An image-forming machine having a detack charging system with an input source to store receiver media. The receiver media includes at least one sheet having a receiver weight. The image-forming machine further includes a marking engine having a central processing unit (CPU) and a detack charger. The marking engine is configured to receive media form the input source. The CPU includes a memory and is configured to receive and store a receiver weight limit from an interface device. The CPU is also configured to enable the detack charger when the weight of a receiver sheet is less than or equal to the receiver weight limit.

### REFERENCE TO EARLIER FILED APPLICATION

This application claims the benefit of the filing date pursuant to 35 U.S.C. §119(e) of Provisional Application Serial No. 60/105,705 filed Jan. 19, 2001, the entire disclosure of which is hereby incorporated by reference.

### FIELD OF THE INVENTION

This invention relates to a detack charger for an electrographic image-forming machines. More particularly, this invention relates to a programmable detack charging system.

### BACKGROUND OF THE INVENTION

An electrographic image-forming machine transfers images onto paper or other medium. For example, an electrographic image-forming machine may include a photoconductor, one or more chargers including a detack charger, an exposure machine, a toning station, a fuser station, and a cleaner, all of which are collectively known as a marking engine. The image-forming machine also has an environmental system, which may be an air exchanger, fan, or similar device to pull or push air through the image-forming machine. A more detailed description of an electrographic image-forming apparatus is described in U.S. patent application Ser. No. 09/736,656, which is incorporated herein by reference.

Generally, the photoconductor is selectively charged and optically exposed to form an electrostatic latent image on the surface. Toner is deposited onto the photoconductor surface. The toner is charged, thus adhering to the photoconductor surface in areas corresponding to the electrostatic latent image. The toner image is transferred onto a receiver sheet. A receiver sheet can be a sheet of paper, a transparency or other medium. In the fuser station, the sheet is heated causing the toner to fix or adhere to the paper or other medium. The photoconductor is refreshed, cleaned to remove residual toner and charge, and is then ready to make another image. The sheet exits the image-forming equipment.

In the marking engine, a detack charger is used to reduce the amount of surface charge on a receiver sheet following electrostatic image transfer. Reducing the amount of receiver surface charge reduces the electrostatic force holding the receiver to the photoconductor surface thus improving the reliability of separating the receiver from the photoconductor after imaging of the receiver. Typically a detack charger is only needed for lightweight receivers (i.e.<70 gm paper, such as, 64 gm). Heavier stock receivers have sufficient beam strength to separate from the film surface on their own. For this reason, the marking engine is programmed to only run the detack charger when feeding lightweight receivers. When an operator uses the marking engine, he programs the engine so that the receiver weight in each paper drawer is identified. The engine is programmed to read this information from memory and activate the detack charger when lightweight paper is fed from a supply. This is done to reduce the amount of running time on the detack charger since contamination builds up on the wire while the detack charger is enabled, and performance is degraded. This contamination must be cleaned off periodically. This service function requires the charger to be removed and cleaned manually. Reducing the run time on the charger then increases the time between required manual cleanings.

### BRIEF SUMMARY OF THE INVENTION

According to an aspect of the invention, the receiver weight limit for detack operation in a detack charging system is programmable. Thus, allowing the detack charger to be utilized for any weight paper or other medium to ensure that image disruption does not occur and separation does occur. This function can be made available to the customer and/or the field engineer. A weight limit is entered via an operator interface of an electrographic image-forming apparatus (touch screen, laptop, etc.). After entry of this value, the marking engine will activate the detack charger when a receiver with a weight lighter than or equal to the limit value is fed through the apparatus. In this way the detack charger can be utilized for any weight paper and ensures that image disruption does not occur. This programmable function provides flexibility while still maintaining the ability to limit the total time the detack charger operates so that an acceptable service interval can be maintained.

### BRIEF DESCRIPTION OF THE DRAWINGS

FIG. 1 is a schematic diagram of an embodiment of an image-forming machine having a transfer charger;

FIG. 2 is an enlarged cross-sectional view of a transfer station for the image-forming machine shown in FIG. 1;

FIG. 3 is an embodiment of a paper catalog user interface screen for the image-forming machine shown in FIG. 1;

FIG. 4 shows an embodiment of a receiver sheet weight user interface screen for the image-forming machine shown in FIG. 1; and

FIG. 5 shows an embodiment of a detack charger/paper weight setpoint screen for the image-forming machine shown in FIG. 1.

### DETAILED DESCRIPTION OF THE INVENTION

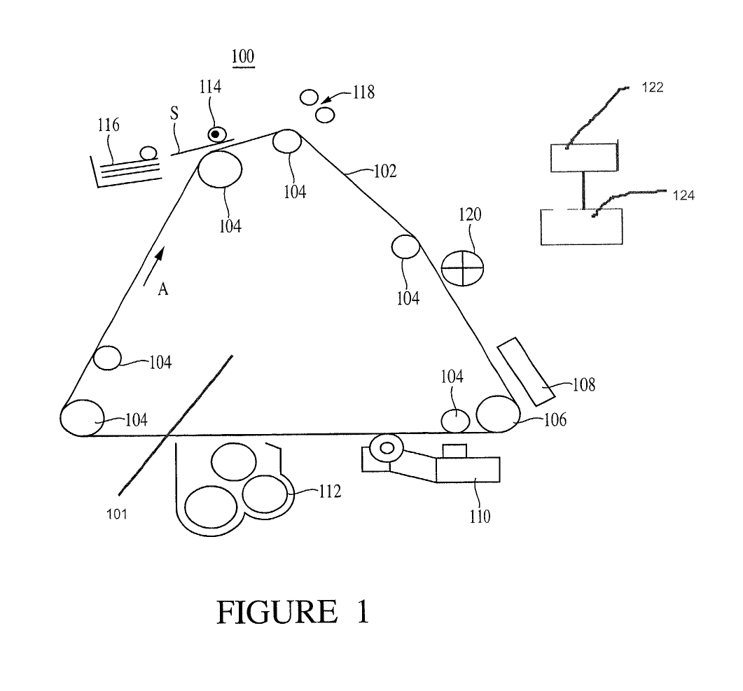

In accordance with the present invention, FIG. 1 is a representative schematic diagram of an embodiment of an image-forming machine 100 having a transfer charger 114. The transfer charger 114 is adjacent, on the downstream side, to the detack charger 208 (not shown in this figure). The image-forming machine 100 may be an electrographic image-forming machine, such as, a printer, a copy machine, a facsimile machine, an electro-photographic image-forming machine, and the like. Along with the transfer charger 114, the image-forming machine 100 may include a photoconductor 102, support rollers 104, a motor driven roller 106, a primary charger 108, an exposure machine 1 10, a toning station 112, a fuser station 118, a cleaner 120, a central processing unit 124, an interface 122, a display (not shown), an input device (not shown), related equipment, accessories, and the like. The photoconductor may take a variety of forms including a film loop belt and drum. The related equipment and accessories may be a feeder 116, a discharge tray (not shown), an inverter (not shown), a housing (not shown), and the like. The feeder 116 provide one or more receiver sheets S. Receiver sheet S may be a sheet of paper, a transparency, a tabloid or the like. The image-forming machine 100 may have other equipment such as an inserter (not shown) and a finisher (not shown). While particular configurations and arrangements are shown, other configurations and arrangements may be used including those with other and additional components.

The central processing unit 124 controls many or all aspects of the image-forming machine 100. The central processing unit 124 may be physically implemented using one or more data processors, in a conventional or parallel computing architecture, or a logic and control unit to control the image-forming machine 100.

The interface 122 supports a user's selection of features of the image-forming machine 100 or preferences in the ultimate presentation of the output set produced by the image-forming machine 100. For example, a user can use the interface 122 to access a menu system that includes a catalog of receiver sheet attributes. The attributes are soft attributes, such as, weight, type, color, detack or no detack. The user can select the attributes he wants for each receiver sheet S he wants to use. The user can then assign those receiver sheets S to a particular bin or feeder 116. In this way, the user can define how the marking engine will process each receiver sheet S in each feeder 116. For instance, the user can program five receiver sheets S in one feeder 116 to be detacked and ten receiver sheets S in another feeder 116 to be detacked. Furthermore, the receiver sheets S can be in any order and have any attribute. This increases the flexibility of the image-forming machine.

The display (not shown) of the interface 122 may have separate screens dedicated to corresponding functions, such as, displaying various statuses, including error messages and structuring the setup of the image-forming machine 100.

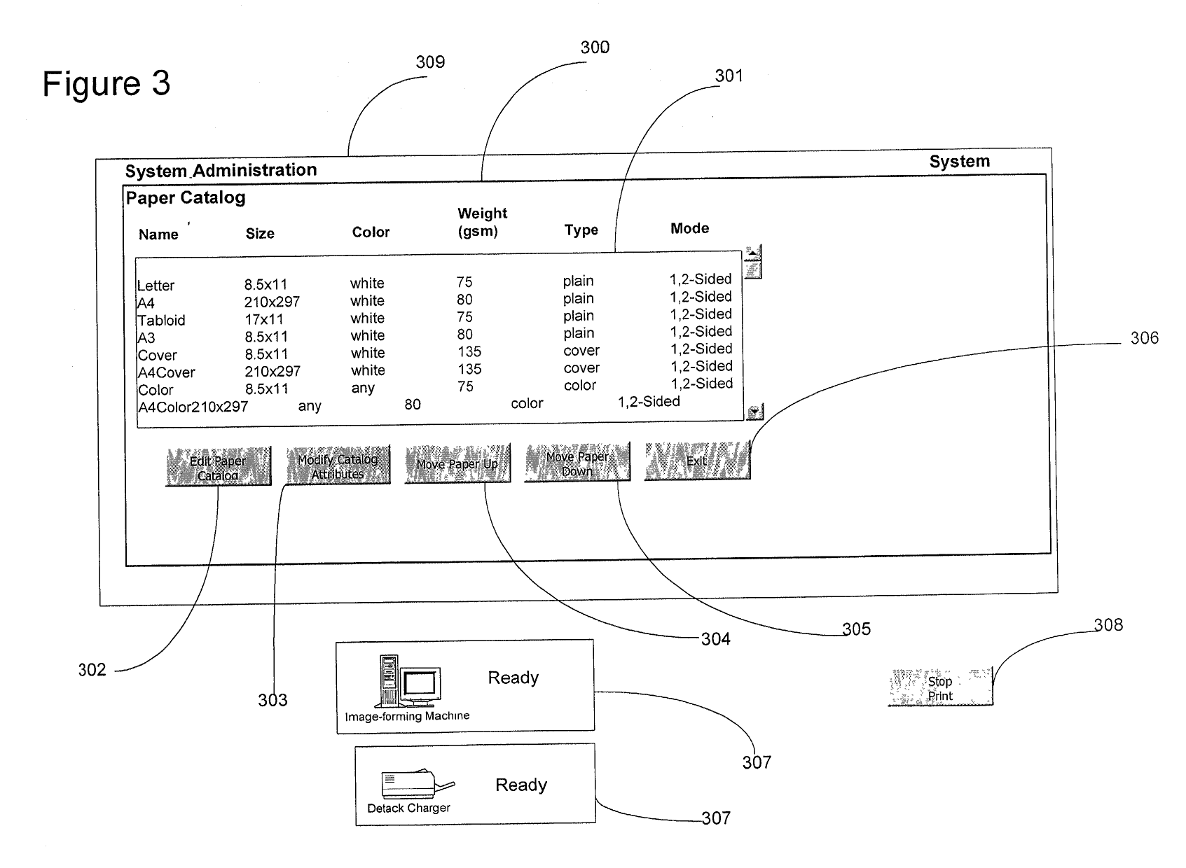

For example, FIG. 3 shows an embodiment of a paper catalog user interface screen 300 for the image-forming machine 100 shown in FIG. 1. The paper catalog user interface screen 300 displays the Name, Size, Color, Weight, Type and Mode for each receiver sheet S in a feeder 116, in a display box 301. Typically, the paper catalog user interface screen 300 is a child screen of a system administration screen 309. The paper catalog user interface screen 300 includes a edit paper catalog button 302, a modify catalog attributes button 303, a move paper up button 304, a move paper down button 305 and an exit button 306. By selecting the appropriate button, the user may edit the paper catalog, modify the attributes of a receiver sheet S, move the receiver sheet S up or down in the paper catalog or exit the paper catalog user interface screen 300. The paper catalog user interface screen 300 also includes a status indicator 307 and a stop print button 308. The status indicator 307 may include one or more indicators such as the image-forming machine 100, the detack charger 208 or the like that shows the status of the indicated device. The stop print button 308 allows the user stop printing a print job, such as when there is an error indicated by the status indicator 307.

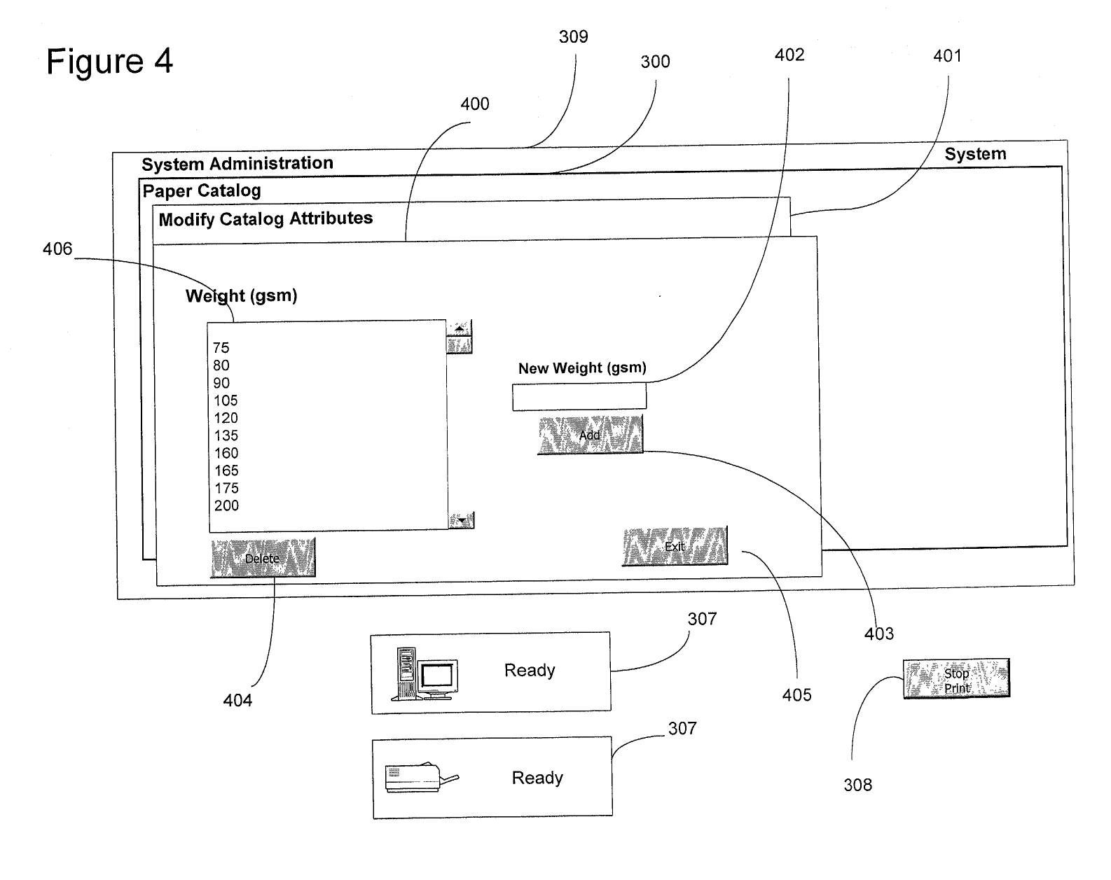

FIG. 4 shows an embodiment of a receiver sheet weight user interface screen 400 for the image-forming machine 100 shown in FIG. 1. The receiver sheet weight user interface screen 400 may be a child screen of a modify catalog attributes screen 401. The modify catalog attribute screen 401 may be a child screen of the paper catalog user interface screen 300. The receiver sheet weight user interface screen 400 displays the weight of each receiver sheet S in a feeder 116, in a display box 406, in order. The receiver sheet weight user interface screen 400 includes a new weight input box 402, an add button 403, a delete button 404 and an exit button 405. An user may select a particular receiver sheet S weight, such as 75, from the display box 406 and change the weight by inputting the new weight in the new weight input box 402 and pressing the add button 403. The user may also delete a receiver sheet S weight by depressing the delete button 404. The exit button 405 allows the user exit out of the receiver sheet weight user interface screen 400. The receiver sheet weight user interface screen 400 also includes a status indicator 307 and a stop print button 308. The status indicator 307 may include one or more indicators such as the image-forming machine 100, the detack charger 208 or the like that shows the status of the indicated device. The stop print button 308 allows the user stop printing a print job, such as when there is an error indicated by the status indicator 307.

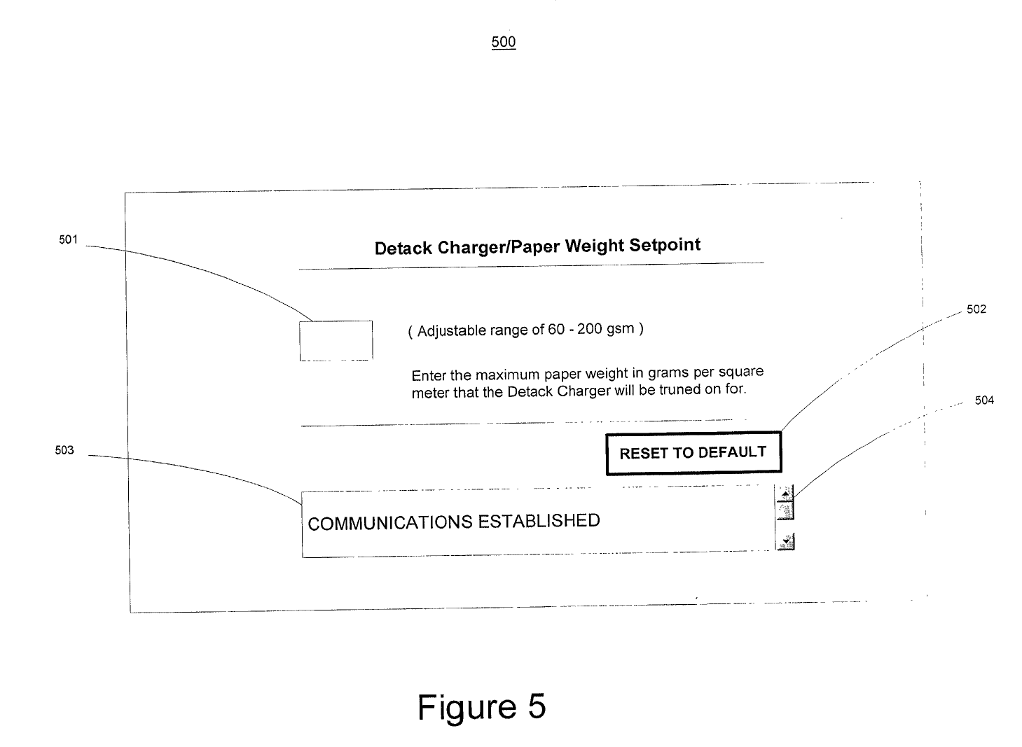

FIG. 5 shows an embodiment of a detack charger/paper weight setpoint screen 500 for the image-forming machine 100 shown in FIG. 1. The detack charger/paper weight setpoint screen 500 displays an input box 501, a rest to default button 502 and a detack status display 503. The input box 501 allows an user to enter the maximum paper weight in grams per square meter (gsm) that the detack charger 208 will be turned on for. For example, the user may enter 70 into the input box 501, which would then turn on the detack charger 208 for all receiver sheet S whose weight is less than or equal to 70 gsm. Typically, the user may pick the maximum paper weight from an adjustable range of weights, such as 60-200 gsm. The reset to default button 502, when pressed, sets the maximum paper weight to a predetermined value, such as 80 gsm. The detack status display 503 gives an indication of when communications is established with the detack charger 208 or when an error occurs. A scroll bar 504 is provided in the event the message displayed in the detack status display 503 does not fit within the detack status display 503 area. Embodiments of the image-forming machine 100 will now be discussed.

In an preferred embodiment, the photoconductor 102 is operatively mounted on the support rollers 104 and the motor driven roller 106, which moves the photoconductor 102 in the direction indicated by arrow A. The primary charger 108, the exposure machine 110, the toning station 112, the transfer charger 114, the fuser station 118, and the cleaner 120 are operatively disposed adjacent to the photoconductor 102. The feeder 116 is operatively disposed to provide a receiver sheet S to the transfer charger 114. Multiple sheets may be processed in this manner or the like. The photoconductor 102 has a belt and roller-mounted configuration and may have a drum or other suitable configuration. The housing supports and protects various components of the image-forming machine 100, which may be integrated with or part of the housing.

In use, the primary charger 108 electrostatically charges a frame on the photoconductor 102. The exposure machine 110 optically exposes and forms an electrostatic image on the frame. The toning station 112 applies toner onto the frame. The toner has a charge to adhere to the electrostatic image. The transfer charger 114 transfers the toner from the frame onto a receiver sheet S from the feeder 116. The fuser station 118 receives the receiver sheet S from the transfer charger 114 and fuses the toner onto the receiver sheet S. The receiver sheet S then exits the image-forming machine 100. Although described with reference to a particular electrographic process, the invention is not so limited and may be implemented in other types of electrographic processes.

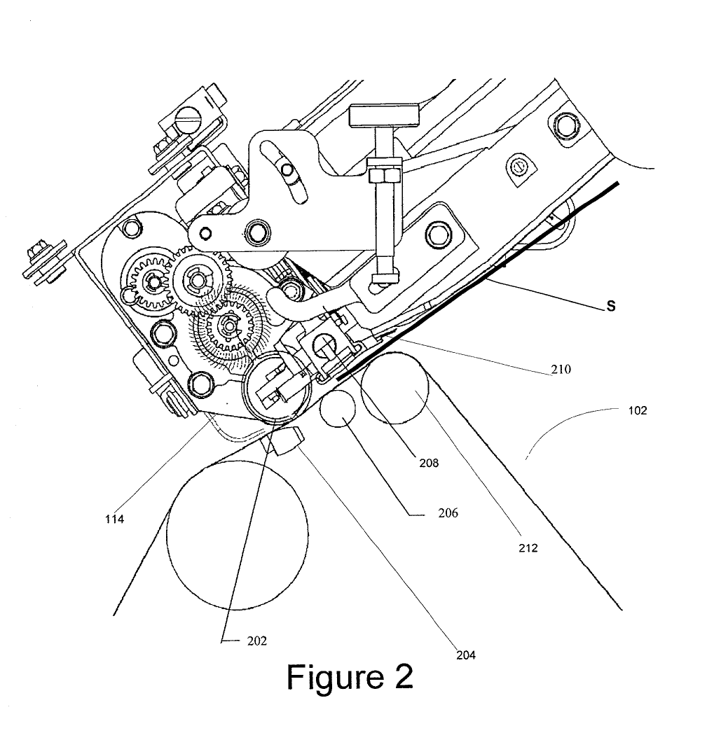

FIG. 2 along with FIG. 1 will now be discussed. FIG. 2 shows an enlarged cross-sectional view of a transfer station 214 that incorporates the transfer charger 114 and the detack charger 208. An example of a transfer station 214, a transfer charger 114, and a detack charger 208 is disclosed in U.S. Pat. Nos. 4,728,880 and 6,097,913 the entire contents of each of which is incorporated herein by reference. As discussed above, an operator inputs through the interface 122 the receiver weight for each receiver sheet S in each paper drawer and the receiver weight limit. It is to be noted here that the receiver weight limit may be inputted using a display (i.e. touch screen), a dial with weights inscribed on it, a slide with weights inscribed on it, a keyboard or other methods. The receiver weight limit is stored in memory in the central processing unit 124, which is operatively connected to receive the receiver weight limit from the interface 122. The receiver sheet S is stored in an input source, here feeder 116, and fed to the marking engine 101, which is operatively connected to receive receiver sheet S from the feeder 116. As the receiver sheet S arrives at a contact point between the transfer roller 202 and the photoconductor 102, a high potential is applied to the back of the receiver sheet S opposite the polarity of the toner material. An electric field is created between the receiver sheet S and the “ground” reference layer in the photoconductor 102. The field produces a strong attractive force between the charged toner and the receiver sheet S. However, in non-image areas, this electric field attracts the receiver sheet S to the photoconductor 102. The transfer bias voltage can reach +3000 to +4000 V DC depending on the resistance of the transfer roller 202. The detack charger 208 is used to reduce the charge density on the receiver sheet to facilitate the separation of the receiver sheet S. Although described with reference to a transfer roller, the invention is not so limited and could be implemented using a variety of chargers.

Separation of the receiver sheet S and the photoconductor 102 is achieved by tracking the photoconductor 102 over a detack backup bar 206. The stiffness of the receiver sheet S will then force separation to occur. Due to the electrostatic field required to transfer the developed image to the receiver sheet S, the stiffness property of the receiver sheet S is not always sufficient to cause separation. To provide good separation, the charge on the receiver is reduced using the detack charger 208 so that the stiffness of the receiver sheet S will be sufficient to force separation. However, the detack charger 208 does not completely discharge the receiver sheet S while it is still in contact with the photoconductor 102 or the toner will be attracted back to the photoconductor 102. This condition is called toner blow off. Typically, the detack charger 208 is required to reduce the amount of charge by 60%, however this is highly dependent on the photoconductor's 102 geometry and the diameter chosen for the detack roller 212. The charge reduction required can vary from 30% to 85% depending on the marking engine design.

The detack charger 208 is operatively connected to the central processing unit 124 to receive an enable signal or a disable signal. The central processing unit 124 provides the enable signal when the receiver weight of receiver sheet S is less than or equal to the receiver weight limit. The central processing unit 124 provides the disable signal when the receiver weight of receiver sheet S is greater than the receiver weight limit. In practice, the power supply for the detack charger 208 has an enable line that is high when the power supply is off (the charger is not enabled). To turn the power supply on, this enable line is pulled low. The detack charger 208 is enabled by applying an AC voltage to a charger wire (not shown). The detack charger 208 now has a reduced run time thereby increasing the time between required manual cleaning and allowing the detack charger 208 to eliminate artifacts on both lightweight receivers and nominal weight receivers, particularly those with very smooth surfaces. A static brush 210 mounted to the detack charger 208 is used to reduce any remaining charge on the receiver sheet S.

As described above, the fuser station 118 receives the receiver sheet S from the transfer charger 114 and fuses the toner to the receiver sheet S. The receiver sheet S then exits the image-forming machine 100.

In another embodiment of present invention, the detack charger 208 may be enabled irrespective of the receiver weight of receiver sheet S. For example, when a receiver sheet S is not stiff enough to facilitate separation, even though its receiver weight is greater than the receiver weight limit. In this situation the operator would program the marking engine, through interface 122, to enable the detack charger 208 for this specific receiver sheet S, such as, when a receiver sheet S is placed in a top loader or selected from a receiver catalog. In this way the machine could operate for paper under a certain weight plus specific paper types identified in a receiver catalog. This would add further flexibility to the system so that the detack charger would only be run when needed.

In another embodiment of present invention, the detack charger 208 may be enabled to avoid image disruption, even though a receiver sheet S is stiff enough and its receiver weight is enough to facilitate separation. For example, when it is known that a specific type of receiver sheet S is susceptible to image disruption, the operator can program the marking engine, through interface 122, to enable the detack charger 208 for this specific receiver sheet S.

In another embodiment of present invention, the operator may program the marking engine to enable or disable the detack charger 208 for specific receiver sheets S within a feeder 116. For example, the operator can view a receiver catalog of attributes of the receiver sheets S in the feeder 116 on the display (not shown) and select which receiver sheets S will require the detack charger 208 to be enabled.

In another embodiment of present invention, the operator may designate a specific feeder 116 to have the detack charger 208 enable anytime a receiver sheet S is fed from that specific feeder 116. For example, if an operator knows that all receiver sheets S in a feeder 116 require the detack charger 208 to be enabled, the operator can through service software or the interface 122, program the marking engine to enable the detack charger 208 for this specific feeder 116.

In another embodiment of present invention, the operator may program the marking engine to enable the detack charger 208 for all feeders 116 in the image-forming system 100.

Various embodiments of the invention have been described and illustrated. However, the description and illustrations are by way of example only. Many more embodiments and implementations are possible within the scope of this invention and will be apparent to those of ordinary skill in the art. Therefore, the invention is not limited to the specific details, representative embodiments, and illustrated examples in this description. Accordingly, the invention is not to be restricted except in light as necessitated by the accompanying claims and their equivalents.

What is claimed is:

1. A printing apparatus having a detack charging system, comprising:
a processor; and
a detack charger operatively connected to said processor;
wherein a programmed signal from said computer enables or disables said detack charger in response to a sheet weight of a sheet of paper fed into said printing apparatus.

2. The printing apparatus of claim 1, wherein said detack charging system further comprises:
a feeder to store sheets of paper, said sheets of paper comprising at least one sheet having a sheet weight; and
an interface having an input device and a display, said interface configured for receiving an inputted sheet weight limit, said interface further configured to access a menu system having a catalog of sheet attributes of said at least one sheet, said catalog of sheet attributes configured to allow a user to selectively enable said detack charger for said at least one sheet.

3. The printing apparatus of claim 2, wherein said detack charging system further comprises:
a marking engine comprising a central processing unit (CPU) having a memory to store said sheet weight limit;
said marking engine operatively connected to said feeder to receive said at least one sheet from said feeder;
said CPU operatively connected to said interface to receive said sheet weight limit from said interface; and
said detack charger operatively connected to receive said programmed signal from said CPU.

4. The printing machine of claim 3, wherein said programmed signal enables said detack charger when said sheet weight of said at least one sheet is less than or equal to said sheet weight limit.

5. The digital printing machine of claim 3, wherein said programmed signal disables said detack charger when said sheet weight of said at least one sheet is greater than said sheet weight limit.

6. A printing machine having a detack charging system, comprising:
a computer; and
a detack charger operatively connected to said computer;
wherein a programmed signal from said computer enables or disables said detack charger in response to an attribute of a sheet of paper fed into said printing machine.

7. The printing machine of claim 6, wherein said detack charging system further comprises:
a feeder to store sheets of paper, said sheets of paper comprising at least one sheet having said attribute; and
an interface having an input device and a display, said interface configured for receiving an inputted attribute, said interface further configured to access a menu system having a catalog of sheet attributes of said at least one sheet, said catalog of sheet attributes configured to allow a user to selectively detack said at least one sheet.

8. The printing machine of claim 6, wherein said computer comprises:
a marking engine comprising a central processing unit (CPU) having a memory to store said attribute of said at least one sheet;
said marking engine operatively connected to receive said at least one sheet from said feeder;
said CPU operatively connected to receive said attribute of said at least one sheet from said interface; and
said detack charger operatively connected to receive said programmed signal from said CPU.

9. The printing machine of claim 8, wherein said programmed signal enables said detack charger when said inputted attribute matches a “detack” attribute of said at least one sheet.

10. The printing machine of claim 8, wherein said programmed signal disables said detack charger when said inputted attribute matches a “no detack” attribute of said at least one sheet.

11. A printing machine having a detack charging system, comprising:
a feeder to store sheets of paper, said sheets of paper comprising at least one sheet having a sheet weight;
an interface having an input device and a display, said interface configured for receiving a sheet weight limit, said interface further configured to access a menu system having a catalog of sheet attributes of said at least one sheet, said catalog of sheet attributes configured to allow a user to selectively detack said at least one sheet; and
a marking engine comprising a central processing unit (CPU) having a memory to store said sheet weight limit and a detack charger, said marking engine operatively connected to receive at least one sheet from said feeder, said CPU operatively connected to receive said sheet weight limit from said interface, and said detack charger operatively connected to receive a first and a second signal from said CPU,
where said CPU provides said first signal when said sheet weight of said at least one sheet is less than or equal to said inputted sheet weight limit, and said detack charger is enabled in response to said first signal, and
where said CPU provides said second signal when said sheet weight of said at least one sheet is greater than said inputted sheet weight limit, and said detack charger is disabled in response to said first signal.

12. A method of detack charging in an image-forming machine, comprising:
receiving a sheet a paper from a feeder;
said sheet of paper having a sheet weight;
configuring an interface to receive a sheet weight limit;
storing said sheet weight limit in a memory of a central processing unit (CPU);
configuring said interface to access a menu system;
said menu system having a catalog of sheet attributes of said sheet of paper;
configuring said catalog of sheet attributes to allow a user to selectively detack said sheet of paper;
connecting said CPU to a detack charger for receiving an enable and disable signal;
generating said enable signal from said CPU when said sheet weight is less than or equal to said sheet weight limit and enabling said detack charger; and
generating said disable signal from said CPU when said sheet weight is greater than said sheet weight limit and disabling said detack charger.

13. A method of detack charging in an image-forming machine, comprising:
receiving a sheet a paper from a feeder;
said sheet of paper having a sheet weight;
configuring an interface to receive a sheet weight limit;
generating an enable signal from a central processing unit (CPU) when said sheet weight is less than or equal to said sheet weight limit and enabling a detack charger; and
generating a disable signal from said CPU when said sheet weight is greater than said sheet weight limit and disabling said detack charger.

14. The method of detack charging in an image-forming machine of claim 13 further comprising storing said sheet weight limit in a memory of said CPU.

15. The method of detack charging in an image-forming machine of claim 13 further comprising configuring said interface to access a menu system, said menu system having a catalog of sheet attributes of said sheet of paper.

16. The method of detack charging in an image-forming machine of claim 13 further comprising connecting said CPU to said detack charger for receiving an enabled and disable signal.

17. The method of detack charging in an image-forming machine of claim 15 further comprising configuring said interface to enable said detack charger for a specific sheet of paper.

18. The method of detack charging in an image-forming machine of claim 13 further comprising configuring said interface to enable said detack charger for a specific sheet of paper in a specific feeder.

19. The method of detack charging in an image-forming machine of claim 13 further comprising configuring said interface to enable said detack charger for all sheets of paper in a specific feeder.

20. A printing apparatus having a detack charging system, comprising:
a processor; and
a detack charger operatively connected to said processor;
wherein a programmed signal from said processor controls said detack charger in response to a sheet weight of a receiver sheet fed into said printing apparatus.

21. The printing apparatus of claim 20, wherein said receiver sheet is a sheet of paper.

22. The printing apparatus of claim 20, wherein said receiver sheet is a transparency.

23. The printing apparatus of claim 20, wherein said receiver sheet is a tabloid.

24. The printing apparatus of claim 20, wherein said programmed signal from said processor, comprises a signal to enable or disable said detack charger.

25. The printing apparatus of claim 20, wherein said detack charging system further comprises:
a feeder to store sheets of receiver sheets, said sheets of receiver sheets comprising at least one receiver sheet having a sheet weight; and
an interface having an input device and a display, said interface configured for receiving an inputted sheet weight limit, said interface further configured to access a menu system having a catalog of sheet attributes of said at least one receiver sheet, said catalog of sheet attributes configured to allow a user to selectively enable said detack charger for said at least one receiver sheet.

26. The printing apparatus of claim 25, wherein said detack charging system further comprises:
a marking engine comprising a central processing unit (CPU) having a memory to store said sheet weight limit;
said marking engine operatively connected to said feeder to receive said at least one receiver sheet from said feeder;
said CPU operatively connected to said interface to receive said sheet weight limit from said interface; and
said detack charger operatively connected to receive said programmed signal from said CPU.

27. The printing machine of claim 26, wherein said programmed signal enables said detack charger when said sheet weight of said at least one receiver sheet is less than or equal to said sheet weight limit.

28. The digital printing machine of claim 3, wherein said programmed signal disables said detack charger when said sheet weight of said at least one receiver sheet is greater than said sheet weight limit.

29. A method of detack charging in an image-forming machine, comprising:
receiving a receiver sheet from a feeder;
said receiver sheet having a sheet weight;
configuring an interface to receive a sheet weight limit; and
controlling said detack charger in response to a programmed signal from a central processing unit (CPU) based on said sheet weight limit.

30. The method of detack charging in an image-forming machine of claim 29 wherein controlling said detack charger, comprises:
generating an enable signal from said CPU when said sheet weight is less than or equal to said sheet weight limit and enabling said detack charger; and
generating a disable signal from said CPU when said sheet weight is greater than said sheet weight limit and disabling said detack charger.
